(19) United States
(12) Patent Application Publication
(10) Pub. No.: US 2019/0193162 A1
(43) Pub. Date: Jun. 27, 2019

(54) METHOD FOR MANUFACTURING METAL PRODUCTS HAVING IRREGULAR SHAPES

(71) Applicant: CHAMP TECH OPTICAL (FOSHAN) CORPORATION, Fosham (CN)

(72) Inventors: YI-FAN LIN, Foshan (CN); DUNG-CHANG YEH, New Taipei (TW)

(21) Appl. No.: 15/887,955

(22) Filed: Feb. 2, 2018

(30) Foreign Application Priority Data
Dec. 27, 2017 (CN) 201711449999.8

(51) Int. Cl. B22F 3/16; B23K 1/20; B23K 11/00; B23K 26/26; B28B 1/24; B28B 11/24

(52) U.S. Cl. CPC B22F 3/16; B23K 1/203; B28B 11/243; B23K 26/26; B28B 1/24; B23K 11/002

(57) ABSTRACT

A method for manufacturing metal product having irregular shapes includes steps of providing powder and binding agent, and mixing the powder and binding agent as a mixed feed. The mixed feed is heated to a plastic state, and injected into a mold cavity to form a plurality of blanks. The blanks are degreased to remove the binding agent and are sintered to form workpieces. A substrate or substrates and the workpieces form different parts of the metal product having irregular shapes. The workpieces are disposed on substrate to form a preform and the preform is bonded to form the metal products of irregular shape.

### FIELD

The subject matter herein generally relates to metal injection molding (MIM) field, especially to a metal injection molding method for manufacturing metal products having irregular shapes.

### BACKGROUND

Metal powder injection molding is an industrial technology to prepare metal products. However, some products have special structures, such as an inverted buckle structure, such product is not conducive to demolding in the injection molding process. Large products may have special structures also difficult to mold. The above-mentioned disadvantages need to be overcome.

### BRIEF DESCRIPTION OF THE DRAWINGS

Implementations of the present technology will now be described, by way of example only, with reference to the attached figures.

FIG. 1 is a flowchart of a manufacturing method for metal products having irregular shapes.

FIG. 2A is a cross-section view of workpieces and a substrate in one exemplary embodiment.

FIG. 2B is a cross-section view showing soldering flux applied on jointing surfaces between the workpieces and the substrate and jointing surfaces between adjacent of the workpieces, and assembling the workpieces and the substrate together to form a preform as in FIG. 2A.

FIG. 2C is a cross-section view showing the preform soldered to obtain a metal product having irregular shapes.

FIG. 3A is a cross-section view showing workpieces and a substrate in one exemplary embodiment.

FIG. 3B is a cross-section view showing soldering flux applied on jointing surfaces between the workpieces and the substrate, the workpieces and the substrate being put together to form preform as in FIG. 3A.

FIG. 3C is a cross-section view of preform soldered to obtain a metal product having irregular shapes.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like. The references “a plurality of” and “a number of” mean “at least two.”

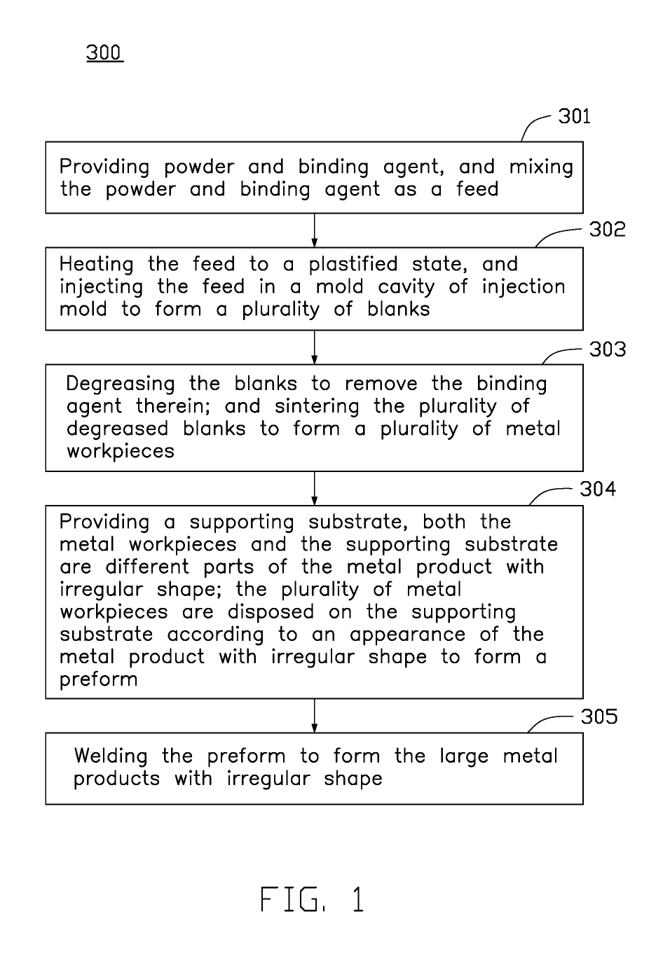

FIG. 1 illustrates a method for manufacturing metal product having irregular shapes according to one embodiment. The method is provided by way of example as there are a variety of ways to carry out the method. The method 300 can be used to manufacture hardware components, industrial machinery components and so on.

At block 301, as shown in FIG. 1, a powder and a binding agent are provided, and the powder and binding agent are feed-mixed. The powder may be selected from metal powder, ceramic powder, or pre-alloyed powder. The diameter of the powder may be in a range between 0.01-50 um, and preferably in a range between 0.1-30 um.

The binding agent may be a wax based binder or a plastic binder.

At block 302, the feed-mix is heated to be in a plastic state, and the feed-mix is injected in different mold cavities of injection molds to form a plurality of blanks. Structure of the blanks may be same with each other or may be different. Each blank undergoes a degreasing process and a sintering process successively to from a workpiece. The plurality of blanks may be formed by powder of same composition or formed by powder of different components. That is, if the plurality of blanks comprises two blanks, and the two blanks named as a first blank and a second blank. The first blank may be has a same component and a same component contents to the second blank. The first blank may be has a same component and a different component contents to the second blank. The first blank may be has a different component to the second blank.

At block 303, the blanks are degreased to remove the binding agent, and the plurality of degreased blanks are sintered to form workpieces, respectively. Each workpiece is one part of the final metal product having irregular shapes. In the embodiment, the plurality of workpieces are having same component and same component contents. In other embodiment, the plurality of workpieces may have same component with same component composition contents, or have same component with different component contents, or have different components.

At block 304, a substrate is provided. The substrate is also one part of the final metal product having irregular shapes and configured to support the plurality of the workpieces. The workpieces are disposed on the substrate according to a required appearance of the metal product having irregular shapes to form a preform. Component of the substrate is different from a component of the workpiece. A material of the substrate is metal formed by a forging method or ceramic. A process method to form the substrate is different from a process method to form the workpiece. The substrate 20 has a better compactness than the workpieces. The substrate is may be formed by a forging method.

At block 305, the preform is bonded to ensure that each workpiece joints firmly with the substrate, and the final metal product having irregular shapes is obtained. By a heating process, powder particles in the workpiece and powder in the substrate contact each other, and thereby, the workpieces and the substrate are strongly bonded.

The bonding method is select from high temperature heat welding, laser welding, or resistance welding. If using high temperature heat welding method, it is necessary to apply flux on jointing surfaces between the workpieces and the substrate and jointing surfaces between adjacent workpieces.

### Example 1

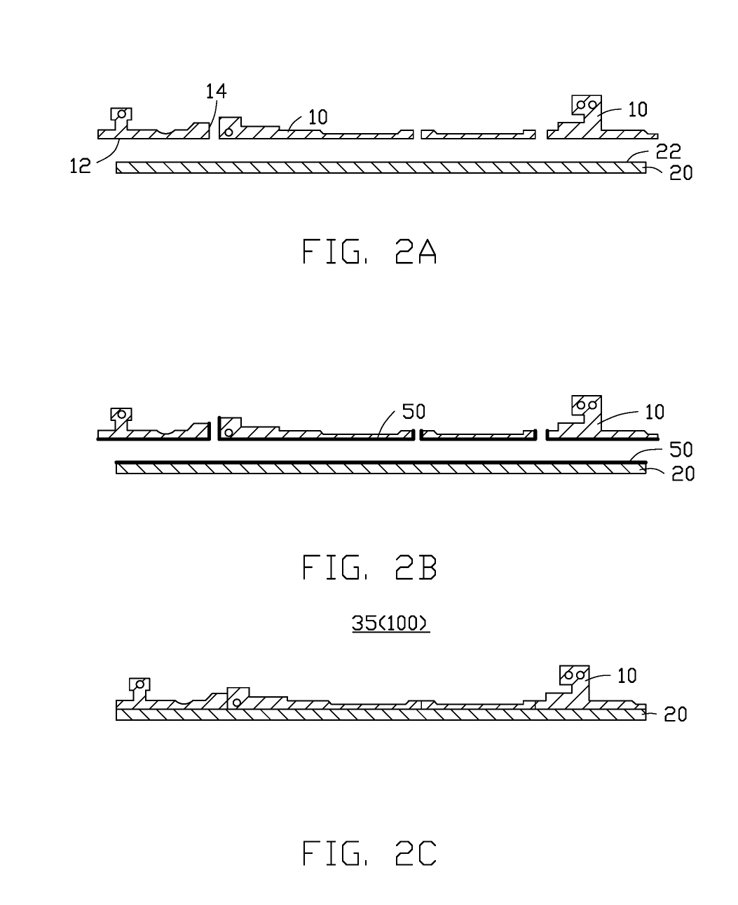

FIG. 2A˜2C show the formation of a large metal product 100 having irregular shape. The large metal product 100 is formed from a plurality of small workpieces 10 and a substrate 20. The plurality of workpieces 10 are each formed by MIM method, and each workpiece 10 has same component, as described in block 301 to block 303. FIG. 2A shows workpieces 10 and substrate 20. In the illustrated embodiment, there are four workpieces 10, and each workpiece 10 is different from others. Component of the substrate 20 is different from component of the workpieces 10, and in the illustrated embodiment, the substrate 20 is substantially made of ceramic. The substrate 20 has a better compactness than the workpieces 10, and the final large metal product 100 can be used for craftwork.

Each of the workpiece 10 includes a jointing surface 12 and a jointing surface 14. The substrate 20 includes a jointing surface 22. When the workpieces 10 are placed on the substrate 20, the workpieces 10 are arranged side by side, and the jointing surface 12 bonds with the jointing surface 22 of the substrate 20. The second jointing surface 14 of one workpiece 10 bonds with the jointing surface 14 of an adjacent workpiece 10.

In FIG. 2B, soldering flux 50 is applied to jointing surfaces 12 and jointing surfaces 22. The workpieces 10 and the substrate 20 together form a preform 35, as in FIG. 2A.

FIG. 2C shows bonding of the preform 35 to obtain the final complex metal product 100. The workpieces 10 and the substrate 20 are strongly bonded. Consequently, the large metal product 100 is directly formed by bonding small workpieces 10 to the substrate 20, rough machining is avoided, and deformation during a sintering process is avoided.

### Example 2

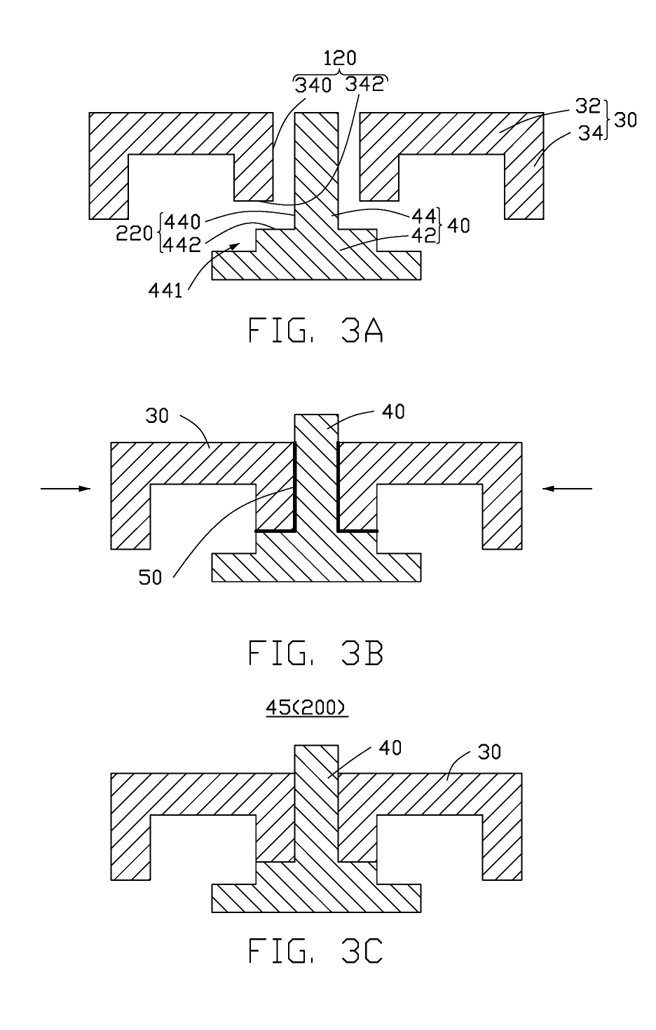

FIG. 3A˜3C show the forming of a metal product 200 of irregular shape, such as an inverted buckle structure. The complex metal product 200 is also formed from workpieces 30 and substrate 40. Structure of the metal product 200 is different from a structure the metal product 100 shown in FIG. 2C. The workpieces 30 are also formed by MIM method, as in block 301 to block 303. In this illustrated embodiment, the workpieces 30 both have the same structure.

As shown in FIG. 3A, each workpiece 30 has substantially a “ [symbol] ” shape, and includes a top plate 32 and a side wall 34 protruding from edges of the top plate 32. The several workpieces 30 together form the inverted buckle structure. The substrate 40 includes a pedestal 42 and a supporting pillar 44 protruding from the pedestal 42, and the pedestal 42 comprises a stepping portion 441.

The supporting pillar 44 is symmetrical about the pedestal 42, the supporting pillar 44 can be cylindrical or prismatic in shape. The first jointing surface 120 includes an outside surface 340 of the side wall 34 and a bottom surface 342 perpendicularly connected with the outside surface 340. The outer side surface 340 may be an arc or a plane. The third jointing surface 220 includes a side surface 440 of the supporting pillar 44 and a top surface 442 surrounding the supporting pillar 44. The upper surface 442 is perpendicular to the side surface 440. The side surface 440 can be cylindrical or flat.

FIG. 3B shows soldering flux 50 applied on the first jointing surfaces 120 of the workpieces 30 and the third joint surface 220 of the substrate 40. The workpieces 30 and the substrates 40 are assembled together to form a preform 45, as in FIG. 3A.

FIG. 3C shows the preform 45 bonded to obtain a metal product 200. The metal product 200 with an inverted buckle structure is thereby obtained.

The embodiments shown and described above are only examples. Therefore, many commonly-known features and details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A method for manufacturing metal products having irregular shapes comprising:
mixing a powder and a binding agent as a feed;
heating the feed to a plastic state;
injecting the feed into a plurality of molds and forming a plurality of blanks;
degreasing the blanks;
sintering the plurality of degreased blanks to form a plurality of workpieces;
providing a substrate, arranging the plurality of workpieces on the substrate in a preform matching a final metal product having an irregular shape; and
bonding the preform to form the final metal product.

2. The method of claim 1, wherein component of the substrate is different from a component of the workpiece.

3. The method of claim 2, wherein the plurality of blanks are formed by powder of same composition with a same component, or formed by powder of same composition with different same components or formed by powder of different components.

4. The method of claim 1, wherein a process method to form the substrate is different from a process method to form the workpiece.

5. The method of claim 4, wherein the substrate is formed by a forging method.

6. The method of claim 1, wherein the powder is selected from metal powder, ceramic powder, or pre-alloyed powder.

7. The method of claim 1, wherein the welding method comprises high temperature heating welding, laser welding or resistance welding.

8. The method of claim 1, wherein each workpiece is jointed to the substrate via jointing surfaces on both the workpiece and the substrate.

9. The method of claim 8, wherein each workpiece is jointed a neighboring workpiece via jointing surfaces on both workpieces.

10. The method of claim 9, wherein the welding method is high temperature heating welding, and soldering flux is applied to the jointing surfaces.

11. The method of claim 9, wherein the substrate comprises a flat surface, and the plurality of the workpieces are disposed on the flat surface.

12. The method of claim 8, wherein the substrate comprises a pedestal and a supporting pillar protruding from the pedestal.

13. The method of claim 12, wherein the pedestal comprises a stepping portion, the stepping portion comprises a top surface and the supporting pillar protruding from the top surface.

14. The method of claim 13, wherein the plurality of the workpieces have same structure, each workpieces is substantially “ [symbol] ” shape, the plurality of workpieces together form the inverted buckle structure, each workpiece comprises a top plate and a side wall extending protrude from edges of the top plate, the first jointing surface comprises an outside surface of the side wall and a bottom surface perpendicularly connected with the outside surface.
